(19) United States
(12) Patent Application Publication
(10) Pub. No.: US 2025/0108666 A1
(43) Pub. Date: Apr. 3, 2025

(54) PNEUMATIC TIRE AND METHOD OF MANUFACTURING SAME

(71) Applicant: Toyo Tire Corporation, Itami-shi (JP)

(72) Inventor: Harunobu SUITA, Itami-shi (JP)

(73) Assignee: Toyo Tire Corporation, Itami-shi (JP)

(21) Appl. No.: 18/884,395

(22) Filed: Sep. 13, 2024

(30) Foreign Application Priority Data
Sep. 29, 2023 (JP) 2023-170246

(51) Int. Cl. B60C 19/00; B29D 30/00; B60C 9/02; B60C 9/12

(52) U.S. Cl. CPC B60C 19/00; B29D 30/0061; B60C 9/12; B60C 2009/0284

(57) ABSTRACT

A carcass ply includes an up ply and a down ply, the up ply including an up ply body that extends from a tread via a pair of sidewalls onto inner sides of a pair of beads in a tire axial direction, and a wrap-up portion that is continuous with the up ply body and is wrapped around a bead core and folded back so as to extend outward in a tire radial direction, the down ply extending from the tread via the pair of sidewalls onto outer sides of the pair of beads in the tire axial direction. An electronic component is sandwiched between the wrap-up portion of the up ply and the down ply and is disposed further outward in the tire radial direction than an inner end of a sidewall rubber in the tire radial direction.

### CROSS-REFERENCE TO RELATED APPLICATIONS

This application is based on and claims the benefit of priority from Japanese Patent Application No. 2023-170246, filed on 29 Sep. 2023, the content of which is incorporated herein by reference.

### FIELD

The present invention relates to a pneumatic tire having an electronic component such as a RFID tag embedded therein, and a method of manufacturing the same.

### BACKGROUND

There is a known pneumatic tire in which an RFID tag including an RFID chip and an antenna is embedded, and information stored in the RFID chip is read by a reader of external equipment via wireless communication, whereby various types of management regarding the tire can be performed. The types of management include manufacture management, supply chain management, usage history management, and the like. For example, a period of use of the tire, a distance travelled, a wear state, a history of external damage, an air pressure, an inspection timing, and the like can be checked in a state where the tire is fit to a vehicle. This type of RFID tag is disposed outward in the tire axial direction with respect to a bead filler and is sandwiched between a cord reinforcing layer and a ply end reinforcing rubber, for example (Japanese Unexamined Patent Application, Publication No. 2016-49920, FIG. 4).

### SUMMARY

Incidentally, manufacture of a pneumatic tire includes a step of wrapping, around a bead, a portion of a member such as the cord reinforcing layer and a carcass ply forming the tire skeleton, so that the resulting wrap-up portion is disposed outward in the tire axial direction (which may be referred to as a turn-up step). As in Japanese Unexamined Patent Application, Publication No. 2016-49920, in the case of a configuration in which an RFID tag is disposed on a side of a wrap-up portion of this kind of member facing a bead filler, the RFID tag is placed in advance, and thereafter, the wrap-up portion is wrapped up to cover the RFID tag. Here, there is a concern that when the RFID tag is covered with the wrap-up portion, the wrap-up portion in contact with the RFID tag may receive stress from the RFID tag and be deformed or damaged. In addition, the contact of the wrap-up portion with the RFID tag may cause displacement of the RFID tag, which may lead to deterioration of positional accuracy.

The present invention has been achieved in view of the disadvantages described above, and an object thereof is to provide a pneumatic tire and a method of manufacturing the pneumatic tire that are capable of reducing damage to a carcass ply around an electronic component, such as an RFID tag or the like, that is disposed outward in a tire axial direction with respect to a bead filler and suppressing deterioration of positional accuracy of the electronic component.

A first aspect of the present invention is directed to a pneumatic tire including: a pair of beads each including a bead core and a bead filler extending outward in a tire radial direction from the bead core; a pair of sidewalls respectively extending outward in the tire radial direction from the pair of beads; a tread disposed between the pair of sidewalls; and a carcass ply spanning between the pair of beads and embedded in the pneumatic tire. The sidewalls each include a sidewall rubber. The carcass ply includes an up ply and a down ply. The up ply includes an up ply body that extends from the tread via the pair of sidewalls onto inner sides of the pair of beads in a tire axial direction, and a wrap-up portion that is continuous with the up ply body and is wrapped around the bead core and folded back so as to extend outward in the tire radial direction. The down ply extends from the tread via the pair of sidewalls onto outer sides of the pair of beads in the tire axial direction. An electronic component is sandwiched between the wrap-up portion of the up ply and the down ply and is disposed further outward in the tire radial direction than an inner end of the sidewall rubber in the tire radial direction.

A second aspect of the present invention is directed to a method of manufacturing the pneumatic tire described above, the method including: arranging the pair of beads on the up ply; forming the wrap-up portion by wrapping a portion of the up ply around the bead; disposing the electronic component on an outer side of the wrap-up portion in the tire axial direction; and disposing the down ply over the wrap-up portion to cover the electronic component with the down ply.

The pneumatic tire and the method of manufacturing the pneumatic tire according to the present invention are capable of reducing damage to the carcass ply around the electronic component, such as an RFID tag or the like, that is disposed outward in the tire axial direction with respect to the bead filler and suppressing deterioration of positional accuracy of the electronic component.

### BRIEF DESCRIPTION OF THE DRAWINGS

FIG. 1 is cross-sectional view of a pneumatic tire according to an embodiment, taken along a tire axial direction;

FIG. 2 is an enlarged view of a portion indicated by II in FIG. 1;

FIG. 3 is a partial perspective view schematically illustrating a structure of an up ply of a carcass ply according to an embodiment;

FIG. 4A is a plan view of an RFID tag that is embedded in the pneumatic tire according to the embodiment;

FIG. 4B is a cross-sectional view taken along line b-b in FIG. 4A;

FIG. 4C is a cross-sectional view taken along line c-c in FIG. 4A; and

FIG. 5 is a graph illustrating shear strain of a carcass ply in simulation performed in an Example.

### DETAILED DESCRIPTION OF THE EMBODIMENTS

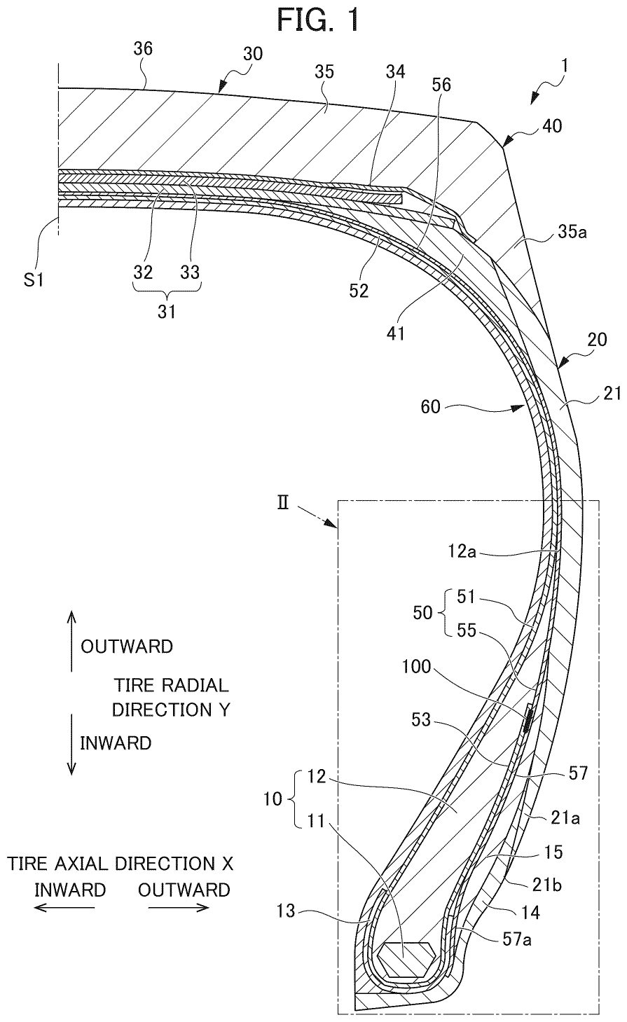

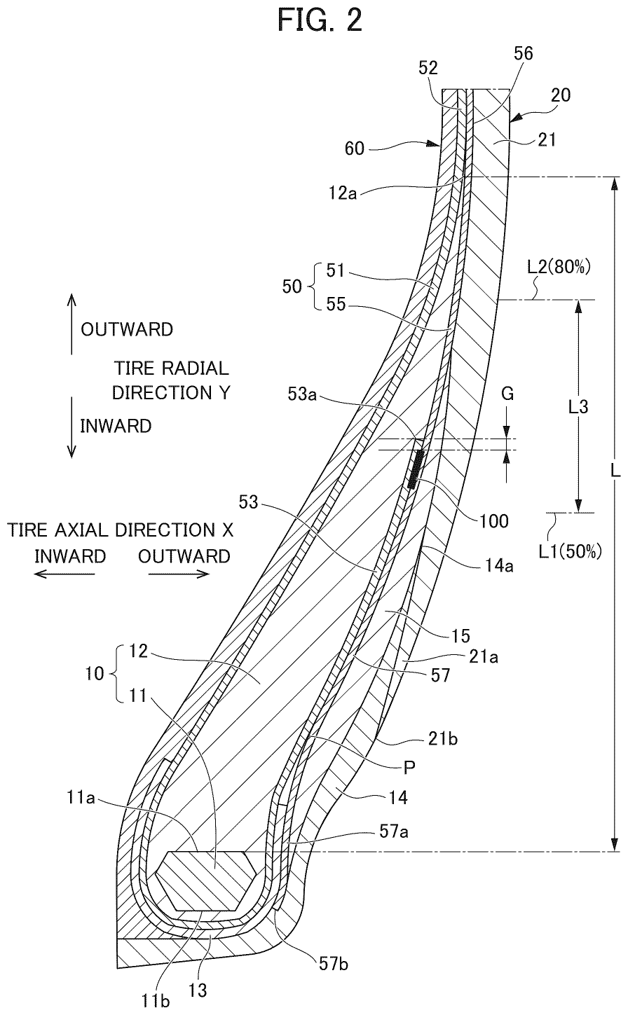

Embodiments will be described with reference to the drawings. FIG. 1 is a diagram illustrating an internal structure of a tire 1, which is a pneumatic tire according to an embodiment, and shows a cross section along a tire axial direction. FIG. 2 is an enlarged view of a portion indicated by II in FIG. 1. The tire 1 according to the embodiment is, for example, a pneumatic tire for a light truck.

First, the internal structure of the tire 1 will be described with reference to FIGS. 1 and 2.

The cross-sectional view of FIG. 1 is a tire axial cross-sectional view (tire meridian cross-sectional view) in a no-load state in which the tire 1 fit on a regular rim (not shown) is filled to a regular internal pressure. The “regular rim” is defined by a standard for each tire in a standards system that includes the standard with which the tire complies. For example, a regular rim is a “standard rim” in JATMA and a “measuring rim” in TRA and ETRTO. The “regular internal pressure” is an air pressure defined by a standard for each tire in a standard system that includes the standard with which the tire complies. In the case of a truck/bus tire or a light truck tire, the regular internal pressure is the maximum air pressure in JATMA, the maximum value in the table “TIRE LOAD LIMITS AT VARIOUS COLD INFLATION PRESSURES” in TRA, and “INFLATION PRESSURE” in ETRTO. In the case of tires for passenger cars, the regular internal pressure is normally set to 180 kPa; but in the case of a tire bearing “Extra Load” or “Reinforced”, the regular internal pressure is set to 220 kPa.

In FIG. 1, the reference sign S1 denotes a tire equatorial plane. The tire equatorial plane S1 is a plane orthogonal to a tire rotation axis and located at the center of the tire 1 in the tire axial direction. The basic internal structure of the tire 1 is bilaterally symmetric with respect to the tire equatorial plane S1 as a plane of symmetry, in a cross section along the tire axial direction.

Here, the tire axial direction is a direction parallel to the tire rotation axis and corresponds to a lateral direction on the pages of FIGS. 1 and 2. It is indicated as “TIRE AXIAL DIRECTION X” in FIGS. 1 and 2. The term “inward in the tire axial direction” refers to a direction toward the tire equatorial plane S1 and corresponds to a direction toward the center on the pages of FIGS. 1 and 2. The term “outward in the tire axial direction” refers to a direction away from the tire equatorial plane S1 and corresponds to a leftward direction and a rightward direction on the pages of FIGS. 1 and 2. A tire radial direction is a direction perpendicular to the tire rotation axis and corresponds to an up-down direction on the pages of FIGS. 1 and 2. It is indicated as “TIRE RADIAL DIRECTION Y” in FIGS. 1 and 2. The term “outward in the tire radial direction” refers to a direction away from the tire rotation axis and corresponds to an upward direction on the pages of FIGS. 1 and 2. The term “inward in the tire radial direction” refers to a direction toward the tire rotation axis and corresponds to a downward direction on the pages of FIGS. 1 and 2.

As illustrated in FIG. 1, the tire 1 according to the embodiment includes: a pair of beads 10 provided on both sides in the tire axial direction; a pair of sidewalls 20 respectively extending outward in the tire radial direction from the pair of beads 10; a tread 30 disposed between the pair of sidewalls 20; a pair of shoulders 40 in which the pair of sidewalls 20 transition to the tread 30; a carcass ply 50 spanning between the pair of beads 10; and an inner liner 60 disposed on a side of the carcass ply 50 facing a tire interior cavity.

Each bead 10 includes a bead core 11 and a bead filler 12 that extends outward in the tire radial direction with respect to the bead core 11.

The bead core 11 is an annular member formed by winding a rubber-sheathed metal bead wire in a plurality of turns in a tire circumferential direction. The bead core 11 is a member that plays a role in fixing the tire 1 filled with air to a rim. The bead filler 12 has a tapered shape whose thickness decreases from an inner side toward an outer side in the tire radial direction. The bead filler 12 is provided to increase rigidity of a peripheral portion of the bead 10 and to ensure high maneuverability and stability. The bead filler 12 is made of, for example, a rubber having a higher hardness than neighboring rubber members.

An inner end of each bead 10 in the tire radial direction is surrounded by a chafer 13 with the carcass ply 50 interposed therebetween. Furthermore, a rim strip rubber 14 is disposed to extend outward in the tire radial direction from an inner side of the chafer 13 in the tire radial direction. The rim strip rubber 14 includes a region disposed outward in the tire axial direction with respect to the bead core 11 and a portion of the bead filler 12. The rim strip rubber 14 is to be in contact with an inner surface of a rim on which the tire 1 is fit.

Each sidewall 20 includes a sidewall rubber 21 that is disposed outward in the tire axial direction with respect to the carcass ply 50. The sidewall rubber 21 constitutes an outer wall surface of the tire 1. As illustrated in FIG. 2, an inner end portion 21a of the sidewall rubber 21 in the tire radial direction covers a portion of the rim strip rubber 14. The sidewall rubber 21 becomes most deflected when the tire 1 performs a cushioning action, and is usually made of a flexible rubber having fatigue resistance.

The tread 30 includes a tread rubber 35, a belt 31, and a cap ply 34. The belt 31 and the cap ply 34 are embedded in the tread rubber 35. The belt 31 is disposed on the outer side of the carcass ply 50 in the tire radial direction. The cap ply 34 is disposed on an outer side of the belt 31 in the tire radial direction.

The belt 31 is a member that reinforces the tread 30. The belt 31 of the embodiment has a two-layer structure including an inner belt 32 and an outer belt 33 stacked on a surface of the inner belt 32 facing the tire outer surface. Each of the belts 32 and 33 has a structure including a plurality of belt cords such as steel cords covered with rubber. The inner belt 32 is wider than the outer belt 33. Providing the belt 31 ensures the rigidity of the tire 1 and improves adhesion of the tread 30 to a road surface. The belt 31 is not limited to the two-layer structure, and may have a structure including one layer or three or more layers.

The cap ply 34 is a member that reinforces the tread 30, together with the belt 31. The cap ply 34 is disposed closer to the tire outer surface and covers the entire belt 31. The cap ply 34 has, for example, a structure including a plurality of rubber-coated organic fiber cords having insulation properties, such as polyamide fibers or the like. Providing the cap ply 34 makes it possible to improve durability and reduce road noise during traveling. The cap ply 34 is not limited to the one-layer structure as in the embodiment, and may have a two-layer structure or a structure having three or more layers. Instead of the cap ply 34 covering the belt 31, an edge ply may be employed to cover ends of the belt 31 in the tire axial direction.

The tread rubber 35 is disposed on an outer side of the cap ply 34 in the tire radial direction. The tread rubber 35 constitutes a tread surface 36, which is an outer surface of the tread 30 and contacts with a road surface. Each of outer end portions 35a of the tread rubber 35 in the tire axial direction protrudes further outward in the tire axial direction than an outer end of the cap ply 34 in the tire axial direction, and bends inward in the tire radial direction to cover an outer end of the sidewall rubber 21 in the tire radial direction.

Each shoulder 40 includes a region corresponding to the outer end portion 35a of the tread rubber 35 in the tire axial direction. In the tire 1 of the embodiment, a shoulder rubber 41 is sandwiched between the tread rubber 35 and the carcass ply 50 in the region corresponding to the shoulder 40. A side of the shoulder rubber 41 facing the tire outer surface is covered with a portion of each of the inner belt 32, the cap ply 34, the tread rubber 35, and the sidewall rubber 21.

The carcass ply 50 constitutes a ply that serves as a skeleton of the tire 1. The carcass ply 50 is embedded in the tire 1 such that it extends between the pair of beads 10 along sides of the pair of sidewalls 20, sides of the pair of shoulders 40, and a side of the tread 30 that face the tire interior cavity. Along the tread 30, the belt 31 is disposed on the outer side of the carcass ply 50 in the tire radial direction.

The carcass ply 50 of the embodiment includes an up ply 51 and a down ply 55. In the region corresponding to the tread 30, the up ply 51 is disposed on an outer side of the inner liner 60 in the tire radial direction, and the down ply 55 is disposed on outer side of the up ply 51 in the tire radial direction.

The up ply 51 includes an up ply body 52 and a pair of wrap-up portions 53. The up ply body 52 extends from the tread 30 via the pair of shoulders 40 and the pair of sidewalls 20 onto the inner sides of the pair of beads 10 in the tire axial direction. The pair of wrap-up portions 53 are continuous with the up ply body 52 and respectively wrap around the pair of bead cores 11 and folded back so as to extend outward in the tire radial direction. Each of the wrap-up portions 53 extends from the bead core 11 to an intermediate point on the bead filler 12 in the tire radial direction.

The down ply 55 extends from the tread 30 via the pair of shoulders 40 and the pair of sidewalls 20 onto the outer sides of the pair of beads 10 in the tire axial direction. The down ply 55 is on a side of the up ply body 52 of the up ply 51 facing the tire outer surface, from the tread 30 to outer ends 12a of the bead fillers 12 in the tire radial direction, and diverges from the up ply body 52 at the ends 12a so as to extend to the outer sides of the bead fillers 12 in the tire axial direction. The down ply 55 includes a down ply body 56 that extends between the ends 12a of the pair of bead fillers 12, and downward portions 57 that extend inward in the tire radial direction from the down ply body 56.

The down ply body 56 of the down ply 55 is disposed over a region from the tread 30 via the pair of shoulders 40 to the ends 12a of the pair of bead fillers 12, the ends 12a being located at intermediate points of the pair of sidewalls 20. The downward portions 57 of the down ply 55 respectively extend from the ends 12a of the bead fillers 12 inward in the tire radial direction on the outer sides of the pair of the bead fillers 12 in the tire axial direction, and then, respectively extend inward in the tire radial direction on the outer sides of the wrap-up portions 53 of the up ply 51 in the tire axial direction. An inner end portion 57a of each downward portion 57 in the tire radial direction covers an outer portion of the chafer 13 in the tire axial direction. An inner end 57b of each downward portion 57 in the tire radial direction is sandwiched between the chafer 13 and the rim strip rubber 14, and is located at substantially the same position as an inner end 11b of the bead core 11 in the tire radial direction, in terms of the tire radial direction.

A cushioning rubber 15 is disposed outward in the tire axial direction with respect to each bead filler 12 so that the cushioning rubber 15 is sandwiched between the downward portion 57 of the down ply 55 and the sidewall rubber 21 and between the downward portion 57 of the down ply 55 and the rim strip rubber 14. The cushioning rubber 15 is covered with the sidewall rubber 21 and the rim strip rubber 14 without being exposed to the tire outer surface, and does not contact with the rim. The hardness of the cushioning rubber 15 is, for example, equivalent to or less than that of the bead filler 12.

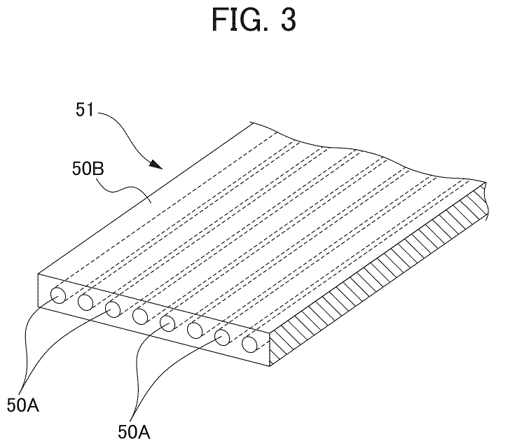

FIG. 3 is a partial perspective view illustrating a configuration of the up ply 51. The down ply 55 has the same or similar configuration. Specifically, as illustrated in FIG. 3, the up ply 51 and the down ply 55 have a configuration in which a plurality of ply cords 50A arranged in parallel with each other are sheathed with a topping rubber 50B. The plurality of ply cords 50A extend, for example, in a plane along the tire axial direction, and are arranged side by side in the tire circumferential direction. Each ply cord 50A is constituted by a code of insulating organic fibers, such as polyester, polyamide, etc. The ply cords 50A of the up ply 51 and the ply cords 50A of the down ply 55 are preferably made of the same material, and the topping rubber 50B of the up ply 51 and the topping rubber 50B of the down ply 55 are preferably made of the same material.

The inner liner 60 is provided between the pair of beads 10, and covers the inner surface of the up ply body 52 of the up ply 51 to thereby form a tire interior cavity surface. The inner liner 60 is made of a rubber impervious to air, and prevents air in the tire cavity from leaking to the outside.

Here, the rubber adopted as the bead fillers 12 has a higher hardness than at least the sidewall rubber 21 and the inner liner 60. The hardness of rubber refers to a hardness tested in accordance with “JIS K6253-3:2012 Durometer method, Type A”.

For example, in a case where the hardness of the sidewall rubber 21 is defined as a reference, the hardness of the bead filler 12 is preferably about 1.2 times or more and about 7 times or less the hardness of the sidewall rubber 21. Adopting the hardness within this range makes it possible to ensure balance between the flexibility of the tire and the rigidity of the vicinity of the beads 10.

As illustrated in FIGS. 1 and 2, an RFID tag 100 as an electronic component is embedded in the tire 1 according to the embodiment.

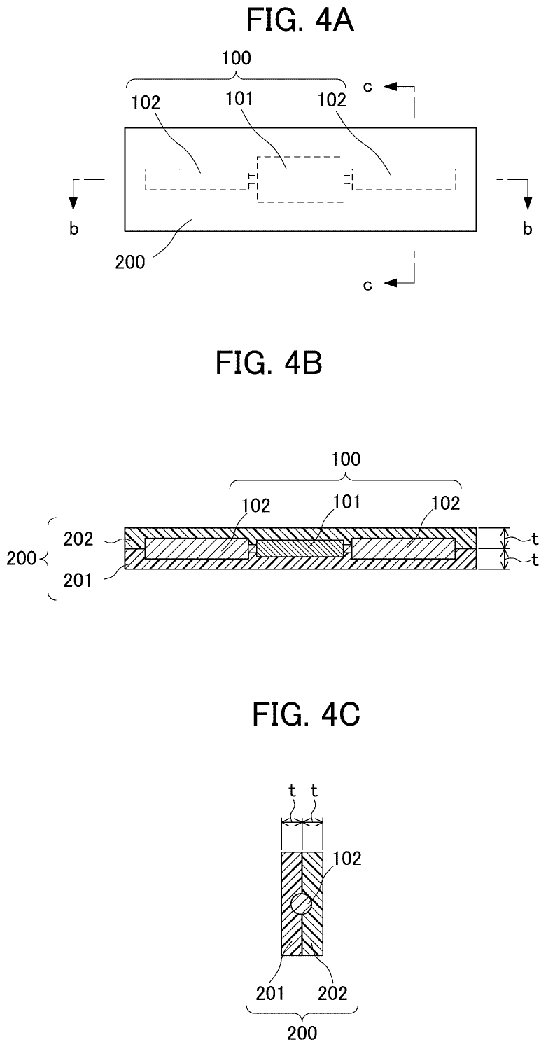

FIGS. 4A to 4C illustrate an example of the RFID tag 100 according to the embodiment. FIG. 4A is a plan view of the RFID tag 100, FIG. 4B is a cross-sectional view taken along line b-b in FIG. 4A, and FIG. 4C is a cross-sectional view taken along line c-c in FIG. 4A.

As illustrated in FIGS. 4A to 4C, the RFID tag 100 is a passive radio frequency identification transponder including an RFID chip 101 and antennas 102 for communicating with external equipment. The RFID tag 100 allows for various types of management related to the tire 1 in such a manner that information stored in the RFID chip 101 is read by a reader of external equipment via wireless communication. The types of management include manufacture management, supply chain management, usage history management, and the like. For example, a period of use of the tire, a distance travelled, a wear state, a history of external damage, an air pressure, an inspection timing, and the like can be checked in a state where the tire is fit to a vehicle.

Examples of the antenna 102 include various antennas such as a coil-shaped spring antenna, a plate-shaped antenna, a rod-shaped antenna, etc. For example, the antenna may be formed by printing a predetermined pattern on a flexible substrate.

As illustrated in FIGS. 4A to 4C, the RFID tag 100 of the embodiment is sheathed with a protective member 200, and is embedded in the tire 1 in the state of being sheathed with the protective member 200.

The protective member 200 includes two rubber sheets 201 and 202 that sandwich and protect the RFID tag 100. The rubber sheets 201 and 202 are preferably made of rubbers having the same quality, i.e., the same formulation. In this case, the rubber sheets 201 and 202 may be integrated after a tire vulcanization step. The rubber sheets 201 and 202 each have a thickness t of preferably 0.5 mm or greater and 1.5 mm or less.

An unvulcanized raw rubber or a vulcanized rubber may be used as the rubber sheets 201 and 202 of the protective member 200. Since the rubber sheets 201 and 202 made of a vulcanized rubber are not plastically deformed unlike raw rubber, the RFID tag 100 can be appropriately protected. The rubber sheets 201 and 202 of the protective member 200 are preferably made of a rubber having the same quality as the topping rubber 50B of the up ply 51 and the topping rubber 50B of the down ply 55, that is, rubber having the same formulation. In this case, after the tire vulcanization step, the rubber sheets 201 and 202 may be integrated, and the topping rubbers 50B of the up ply 51 and the down ply 55 in contact with the rubber sheets 201 and 202 may be integrated with the rubber sheets 201 and 202.

The protective member 200 is not limited to the structure including the two rubber sheets 201 and 202, and various configurations can be adopted. For example, the protective member 200 may be made of one rubber sheet 201, and the rubber sheet 201 may be provided only on one surface of the RFID tag 100. In the case where the protective member 200 is provided on only one surface of the RFID tag 100, the overall thickness can be reduced. The rubber sheet constituting the protective member 200 may cover at least a portion of the RFID tag 100, provided that a stress relaxation effect or the like can be obtained.

As illustrated in FIG. 2, the RFID tag 100 is disposed between the wrap-up portion 53 of the up ply 51 and the downward portion 57 of the down ply 55. In other words, the RFID tag 100 is disposed in a portion where the wrap-up portion 53 of the up ply 51 and the downward portion 57 of the down ply 55 overlap with each other. In the embodiment, the RFID tag 100 is in contact with both the wrap-up portion 53 of the up ply 51 and the downward portion 57 of the down ply 55. The wrap-up portion 53 of the up ply 51 and the downward portion 57 of the down ply 55 are in tight contact with each other around the RFID tag 100. The RFID tag 100 is located further outward in the tire radial direction than an inner end 21b of the sidewall rubber 21 in the tire radial direction.

It is preferable that the RFID tag 100 is spaced apart in the tire radial direction from the wrap-up end 53a, which is an outer end of the wrap-up portion 53 of the up ply 51 in the tire radial direction, by a distance G of 4 mm or greater.

It is preferable that the wrap-up end 53a of the wrap-up portion 53 of the up ply 51 is disposed further outward in the tire radial direction than an outer end 14a of the rim strip rubber 14 in the tire radial direction.

In a case where a distance in the tire radial direction from an outer end 11a of the bead core 11 in the tire radial direction to the outer end 12a of the bead filler 12 in the tire radial direction is defined as a distance L, it is preferable that the wrap-up end 53a of the up ply 51 is located in a range L3 defined between a position LI corresponding to 50% of the distance L and a position L2 corresponding to 80% of the distance L from the outer end 11a of the bead core 11 in the tire radial direction, in terms of the tire radial direction. That is, it is preferable that the wrap-up end 53a of the up ply 51 is disposed within the range L3 corresponding to 50% or more and 80% or less of the distance L from the outer end 11a of the bead core 11 in the tire radial direction, in terms of the tire radial direction.

A method of manufacturing the tire 1 having the above-described configuration includes the following steps.

The method includes a step of arranging a pair of beads 10 on an up ply 51, a step of forming a pair of wrap-up portions 53 by wrapping portions of the up ply 51 around a pair of bead cores 11 and turning up the portions outward in the tire radial direction, a step of disposing a RFID tag 100 sheathed with a protective member 200 on an outer side of one of the pair of wrap-up portions 53 in the tire axial direction, and a step of disposing a down ply 55 on the up ply 51 and placing a downward portion 57 of the down ply 55 over the wrap-up portion 53 to cover the RFID tag 100, which is sheathed with the protective member 200, with the downward portion 57.

The tire 1 according to the embodiment having the above-described configuration exerts the following effects.

(1) A tire 1 according to an embodiment includes: a pair of beads 10 each including a bead core 11 and a bead filler 12 extending outward in a tire radial direction from the bead core 11; a pair of sidewalls 20 respectively extending outward in the tire radial direction from the beads 10; a tread 30 disposed between the pair of sidewalls 20; and a carcass ply 50 spanning between the pair of beads 10 and embedded in the tire. The sidewalls 20 each include a sidewall rubber 21. The carcass ply 50 includes an up ply 51 and a down ply 55. The up ply 51 includes an up ply body 52 and a wrap-up portion 53. the up ply body extends from the tread 30 via the pair of sidewalls 20 onto inner sides of the pair of beads 10 in a tire axial direction. T wrap-up portion 53 is continuous with the up ply body 52 and is wrapped around the bead core 11 and folded back so as to extend outward in the tire radial direction. The down ply 55 extends from the tread 30 via the pair of sidewalls 20 onto outer sides of the pair of beads 10 in the tire axial direction. A RFID tag 100 is sandwiched between the wrap-up portion 53 of the up ply 51 and the down ply 55, and is disposed further outward in the tire radial direction than an inner end 21b of the sidewall rubber 21 in the tire radial direction.

In a case where the tire 1 of the embodiment is manufactured by the above-described method, the RFID tag 100 is disposed on the outer side of the wrap-up portion 53 of the up ply 51 in the tire axial direction, which has been turned up, and thereafter, the downward portion 57 of the down ply 55 is placed over the wrap-up portion 53 so that the RFID tag 100 is covered with the downward portion 57. Therefore, the method does not include a step of turning up the wrap-up portion 53 while covering the RFID tag 100 with the wrap-up portion 53. Accordingly, there is no risk that the wrap-up portion 53 receives stress from the RFID tag 100 during manufacturing. In addition, the down ply 55 is less likely to receive stress from the RFID tag 100 because the downward portion 57 is simply placed over the wrap-up portion 53 of the up ply 51. For these reasons, even though the up ply 51 and the down ply 55 are in contact with the RFID tag 100, they are less likely to receive stress from the RFID tag 100. Thus, the up ply 51 and the down ply 55 are less likely to be deformed or damaged due to the RFID tag 100. Moreover, the absence of the step of turning up the wrap-up portion 53 of the up ply 51 while covering the RFID tag 100 with the wrap-up portion 53 makes it less likely for the RFID tag 100 to be displaced, and as a result, suppresses deterioration of the positional accuracy of the RFID tag 100.
(2) In the tire 1 of the embodiment described above in (1), it is preferable that the RFID tag 100 is spaced apart in the tire radial direction from a wrap-up end 53a, which is an outer end of the wrap-up portion 53 of the up ply 51 in the tire radial direction, by a distance G of 4 mm or greater.

This feature makes it possible to suppress undesired separation of the up ply 51 from the down ply 55 that can be caused by the RFID tag 100 disposed between the wrap-up portion 53 of the up ply 51 and the downward portion 57 of the down ply 55. In a case where the distance G is shorter than 4 mm, there is a high possibility that the plies 51 and 55 will peel off and separate due to the RFID tag 100. Furthermore, since the RFID tag 100 is reliably held between the wrap-up portion 53 of the up ply 51 and the downward portion 57 of the down ply 55, the RFID tag 100 is less likely to be deformed or damaged even during traveling and the like.
(3) In the tire 1 of the embodiment described above in (1) and (2), it is preferable that a rim strip rubber 14 is disposed outward in the tire axial direction with respect to each bead 10, and the wrap-up end 53a, which is the outer end of the wrap-up portion 53 of the up ply 51 in the tire radial direction, is disposed further outward in the tire radial direction than an outer end 14a of the rim strip rubber 14 in the tire radial direction.

This feature ensures a distance between the RFID tag 100 and a rim to which the tire 1 is fit, thereby making it possible to suppress deterioration of communication performance of the RFID tag 100, which can be caused by the influence of the rim. In addition, since the overlapping length of the wrap-up portion 53 of the up ply 51 and the downward portion 57 of the down ply 55 is ensured, undesired separation of the up ply 51 from the down ply 55 is suppressed.
(4) In the tire 1 of the embodiment described above in (1) to (3), in a case where a distance in the tire radial direction from an outer end 11a of the bead core 11 in the tire radial direction to an outer end 12a of the bead filler 12 in the tire radial direction is defined as a distance L, it is preferable that the wrap-up end 53a, which is the outer end of the wrap-up portion 53 of the up ply 51 in the tire radial direction, is located in a range L3 corresponding to 50% or more and 80% or less of the distance L from the outer end 11a of the bead core 11 in the tire radial direction, in terms of the tire radial direction.

Due to this feature, a distance between the bead core 11 and the RFID tag 100 is ensured, thereby making it possible to suppress deterioration of the communication performance of the RFID tag 100, which can be caused by the influence of the bead core 11. In addition, since a distance from the outer end 12a of the bead filler 12 in the tire radial direction, at which the up ply body 52 of the up ply 51 and the down ply body 56 of the down ply 55 diverge from each other, to the wrap-up end 53a of the wrap-up portion 53 of the up ply 51 is ensured, undesired separation of the up ply body 52 from the down ply body 56 is suppressed.
(5) In the tire 1 of the embodiment described above in (1) to (4), it is preferable that each of the up ply 51 and the down ply 55 includes ply cords 50A and a topping rubber 50B with which the ply cords 50A are sheathed, the RFID tag 100 is sheathed with a protective member 200 made of a rubber, and the topping rubber 50B and the protective member 200 are rubbers of the same quality.

Due to this feature, the RFID tag 100 is appropriately protected by the protective member 200. In addition, distortion of the up ply 51 and the down ply 55 around the RFID tag 100 due to deformation of the tire during travelling is suppressed, and the plies 51 and 55 are less likely to be deformed and damaged.
(6) In the tire 1 of the embodiment described above in (5), it is preferable that the ply cords 50A included in the up ply 51 and the ply cords 50A included in the down ply 55 are made of the same material, and the topping rubber 50B included in the up ply 51 and the topping rubber 50B included in the down ply 55 are made of the same material.

Due to this feature, the plies 51 and 55 are less likely to experience uneven distortion that can be caused by the RFID tag 100 sandwiched therebetween, and deformation and damage to the plies 51 and 55 are suppressed.
(7) In the tire 1 of the embodiment described above in (5), it is preferable that the protective member 200 with which the RFID tag 100 is sheathed includes two rubber sheets 201 and 202 sandwiching the RFID tag 100 therebetween, and the rubber sheets 201 and 202 are made of the same quality rubber and each have a thickness of 0.5 mm or greater and 1.5 mm or less.

Due to this feature, the plies 51 and 55 are less likely to experience uneven distortion that can be caused by the RFID tag 100, which is sandwiched between the plies 51 and 55 via the protective member 200, whereby deformation and damage to the plies 51 and 55 are suppressed.
(8) In the tire 1 of the embodiment described above in (5), it is preferable that the protective member 200 includes one rubber sheet that is in contact with at least a portion of the RFID tag 100, and has a thickness of 0.5 mm or greater and 1.5 mm or less.

This feature makes it possible to reduce the overall thickness of the RFID tag 100 and the protective member 200.
(9) A method of manufacturing a tire 1 according to an embodiment is adapted to manufacture the tire 1 of the embodiment described above (1) to (7), and includes: arranging the pair of beads 10 on the up ply 51; forming the wrap-up portion 53 by wrapping a portion of the up ply 51 around the bead 10; disposing the RFID tag 100 on the outer side of the wrap-up portion 53 in the tire axial direction; and disposing the down ply 55 over the wrap-up portion 53 to cover the RFID tag 100 with the down ply 55.

According to this manufacturing method, the RFID tag 100 is disposed on the outer side in the tire axial direction of the wrap-up portion 53 of the up ply 51 that has been turned up in advance, and thereafter, the downward portion 57 of the down ply 55 is disposed over the wrap-up portion 53, whereby the RFID tag 100 is covered with the downward portion 57. Therefore, the manufacturing method does not include a step of turning up the wrap-up portion 53 while covering the RFID tag 100 with the wrap-up portion 53. Accordingly, there is no risk that the wrap-up portion 53 receives stress from the RFID tag 100 during manufacturing. In addition, the down ply 55 is less likely to receive stress from the RFID tag 100 because the downward portion 57 is simply placed over the wrap-up portion 53 of the up ply 51. For these reasons, even though the up ply 51 and the down ply 55 are in contact with the RFID tag 100, they are less likely to receive stress from the RFID tag 100. As a result, it is possible to manufacture a tire in which the up ply 51 and the down ply 55 are less likely to be deformed and damaged. Moreover, the absence of the step of turning up the wrap-up portion 53 of the up ply 51 while covering the RFID tag 100 with the wrap-up portion 53 makes it less likely for the RFID tag 100 to be displaced, and as a result, suppresses deterioration of the positional accuracy of the RFID tag 100.

It should be noted that the present invention is not limited to the above-described embodiment, and modifications, improvements, and the like within a range in which the object of the present invention can be achieved are also encompassed in the scope of the present invention.

For example, each of the up ply 51 and the down ply 55 constituting the carcass ply 50 of the embodiment has a single-layer structure, but may have a two-layer structure or a structure having three or more layers. The number of layers may be the same or different in the up ply 51 and the down ply 55. In any case, the RFID tag 100 is disposed between the wrap-up portion 53 of the up ply 51 and the down ply 55.

In the above embodiment, the RFID tag 100 is exemplified as the electronic component, but the electronic component according to the present invention may be another type of electronic component such as an IC tag or the like.

The RFID tag 100 embedded in the tire 1 does not necessarily have to be sheathed with the protective member 200. That is, the RFID tag 100 without the protective member 200, i.e., only the RFID chip 101 and the antenna 102 may be embedded in the tire 1.

The configuration of the tire 1 according to the above embodiment can be adopted for various vehicles such as a passenger car, a truck, a bus, etc., in addition to a light truck.

### EXAMPLES

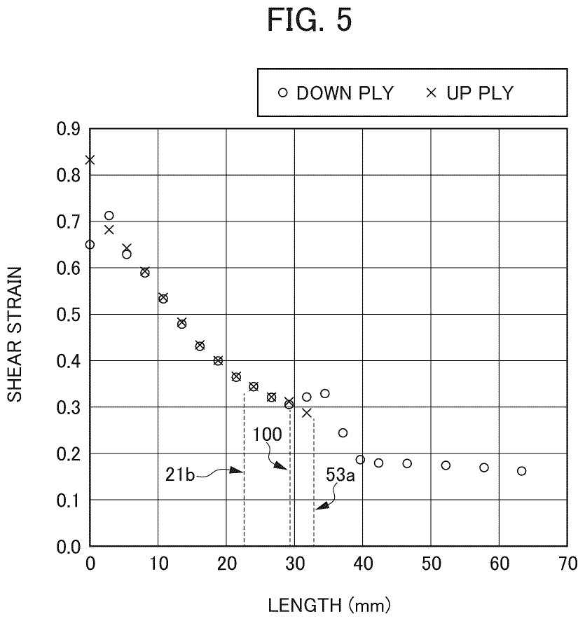

A simulation was performed to measure shear strain generated in a portion where a wrap-up portion 53 of an up ply 51 overlaps with a downward portion 57 of a down ply 55 in a pneumatic tire of “205/85R16” having the same configuration as the above-described embodiment and filled at a regular internal pressure, while a load of 1285 kgf was applied as a 100% load. The results are shown in the graph of FIG. 5. As for the tire standard, the regular internal pressure and the 100% load specified in JATMA were adopted.

FIG. 5 shows a change in a shear strain of the downward portion 57 of the down ply 55 in a range from a starting point (indicated by reference sign P in FIG. 2) that is an inner end in the tire radial direction of the overlapping portion where the wrap-up portion 53 of the up ply 51 overlaps with the downward portion 57 of the down ply 55, through the overlapping portion extending outward in the tire radial direction, i.e., the overlapping portion from the starting point to the wrap-up end 53a of the up ply 51, to the vicinity of the outer end 12a of the bead filler 12 in the tire radial direction. The “LENGTH” represented by the horizontal axis of FIG. 5 is the actual length along each of the deformed plies 51 and 55, and the shear strain was measured at predetermined intervals with respect to the length. In FIG. 5, the positions of the inner end 21b of the sidewall rubber 21 in the tire radial direction, the wrap-up end 53a of the up ply 51, and the RFID tag 100 are also indicated.

FIG. 5 demonstrates that, in the overlapping portion of the wrap-up portion 53 of the up ply 51 and the down ply 55, except for the vicinity of the starting point P, the shear strains have substantially equal values and decrease in a similar way toward the outer side in the tire radial direction, and that the shear strains decrease to a minimum at the wrap-up end 53a. Accordingly, from the viewpoint of minimizing susceptibility to the shear strain, it is desirable that the RFID tag 100 be disposed in the vicinity of the wrap-up end 53a between the wrap-up portion 53 of the up ply 51 and the down ply 55. However, since disposing the RFID tag 100 in the vicinity of the wrap-up end 53a may cause undesired separation of the plies as described above, the RFID tag 100 is preferably disposed at a position that is near the wrap-up end 53a but is inward in the tire radial direction and spaced apart from the wrap-up end 53a by a predetermined distance, and the distance (distance G in FIG. 2) is preferably 4 mm or greater as described above.

What is claimed is:

1. A pneumatic tire comprising:
a pair of beads, each bead including a bead core and a bead filler extending outward in a tire radial direction from the bead core;
a pair of sidewalls respectively extending outward in the tire radial direction from the pair of beads;
a tread disposed between the pair of sidewalls; and
a carcass ply spanning between the pair of beads and embedded in the pneumatic tire,
wherein the sidewalls each include a sidewall rubber,
wherein the carcass ply includes an up ply and a down ply,
the up ply including an up ply body that extends from the tread via the pair of sidewalls onto inner sides of the pair of beads in a tire axial direction, and a wrap-up portion that is continuous with the up ply body and is wrapped around the bead core and folded back so as to extend outward in the tire radial direction,
the down ply extending from the tread via the pair of sidewalls onto outer sides of the pair of beads in the tire axial direction, and
wherein an electronic component is sandwiched between the wrap-up portion of the up ply and the down ply and is disposed further outward in the tire radial direction than an inner end of the sidewall rubber in the tire radial direction.

2. The pneumatic tire according to claim 1, wherein
the electronic component is spaced apart in the tire radial direction from a wrap-up end by a distance of 4 mm or more, and the wrap-up end is an outer end of the wrap-up portion of the up ply in the tire radial direction.

3. The pneumatic tire according to claim 1, wherein
a rim strip rubber is disposed outward in the axial direction with respect to each bead, and
a wrap-up end is disposed further outward in the tire radial direction than an outer end of the rim strip rubber in the tire radial direction, and the wrap-up end is an outer end of the wrap-up portion of the up ply in the tire radial direction.

4. The pneumatic tire according to claim 1, wherein
when a distance in the tire radial direction from an outer end of the bead core in the tire radial direction to an outer end of the bead filler in the tire radial direction is defined as a distance L, a wrap-up end is located in a range of 50% or more and 80% or less of the distance L from the outer end of the bead core in the tire radial direction, in terms of the tire radial direction, and the wrap-up end is an outer end of the wrap-up portion of the up ply in the tire radial direction.

5. The pneumatic tire according to claim 1, wherein
the electronic component is disposed in a portion where the wrap-up portion of the up ply overlaps with a downward portion of the down ply.

6. The pneumatic tire according to claim 5, wherein
the electronic component is in contact with the wrap-up portion of the up ply and the downward portion of the down ply, and
the wrap-up portion of the up ply and the downward portion of the down ply are in tight contact with each other around the electronic component.

7. The pneumatic tire according to claim 1, wherein
each of the up ply and the down ply includes a ply cord and a topping rubber with which the ply cord is sheathed,
the electronic component is sheathed with a protective member made of a rubber, and
the topping rubber and the protective member are rubbers of a same quality.

8. The pneumatic tire according to claim 7, wherein
the ply cord included in the up ply and the ply cord included in the down ply are made of a same material, and
the topping rubber included in the up ply and the topping rubber included in the down ply are made of a same material.

9. The pneumatic tire according to claim 7, wherein
the protective member includes two rubber sheets sandwiching the electronic component therebetween,
the two rubber sheets are made of a same quality rubber, and
each of the two rubber sheets has a thickness of 0.5 mm or greater and 1.5 mm or less.

10. The pneumatic tire according to claim 7, wherein
the protective member includes one rubber sheet that is in contact with at least a portion of the electronic component, and
the one rubber sheet has a thickness of 0.5 mm or greater and 1.5 mm or less.

11. The pneumatic tire according to claim 2, wherein
a rim strip rubber is disposed outward in the axial direction with respect to each bead, and
the wrap-up end is disposed further outward in the tire radial direction than an outer end of the rim strip rubber in the tire radial direction, and the wrap-up end is the outer end of the wrap-up portion of the up ply in the tire radial direction.

12. The pneumatic tire according to claim 2, wherein
when a distance in the tire radial direction from an outer end of the bead core in the tire radial direction to an outer end of the bead filler in the tire radial direction is defined as a distance L, the wrap-up end is located in a range of 50% or more and 80% or less of the distance L from the outer end of the bead core in the tire radial direction, in terms of the tire radial direction, and the wrap-up end is the outer end of the wrap-up portion of the up ply in the tire radial direction.

13. The pneumatic tire according to claim 2, wherein
the electronic component is disposed in a portion where the wrap-up portion of the up ply overlaps with a downward portion of the down ply.

14. The pneumatic tire according to claim 13, wherein
the electronic component is in contact with the wrap-up portion of the up ply and the downward portion of the down ply, and
the wrap-up portion of the up ply and the downward portion of the down ply are in tight contact with each other around the electronic component.

15. A method of manufacturing the pneumatic tire according to claim 1, the method comprising:
arranging the pair of beads on the up ply;
forming the wrap-up portion by wrapping a portion of the up ply around the bead;
disposing the electronic component on an outer side of the wrap-up portion in the tire axial direction; and
disposing the down ply over the wrap-up portion to cover the electronic component with the down ply.
